(19) United States
(12) Patent Application Publication
(10) Pub. No.: US 2020/0138222 A1
(43) Pub. Date: May 7, 2020

(54) IRONING BOARD ATTACHMENT DEVICE

(71) Applicant: Vernon Dickerson, Orlando, FL (US)

(72) Inventor: Vernon Dickerson, Orlando, FL (US)

(21) Appl. No.: 16/178,512

(22) Filed: Nov. 1, 2018

(51) Int. Cl. A47G 29/08; D06F 81/00; F16B 2/06; F16B 2/18; F16M 13/02

(52) U.S. Cl. CPC A47G 29/08; D06F 81/006; F16M 13/022; F16B 2/185; F16B 2/06

(57) ABSTRACT

An ironing board attachment device includes a main body having at least one cup holder that extends upward from the front end. A raised ledge extends along a perimeter of the main body and includes a curvilinear shape for being engaged by a clothes hanger. A bracket and locking mechanism are positioned along the top surface of the main body and function to removably engage the frame of an ironing board to secure the device onto the side of the ironing board without touching the top surface.

### TECHNICAL FIELD

The present invention relates generally to accessories, and more particularly to an ironing board attachment device.

### BACKGROUND

The statements in this section merely provide background information related to the present disclosure and may not constitute prior art.

When ironing garments and other such articles, it is common to apply one or more liquids onto the material in order to relax the fabric. In most cases, the liquid is stored within a spray bottle that is often placed on top of the ironing board or suspended from the side of the board via the trigger portion of the bottle so as to be readily accessible to the user. Additionally, once a garment has been ironed, it is typically placed onto a hanger which is also suspended from the side of the ironing board until it can be put away.

Unfortunately, this arrangement is highly inconvenient as the presence of such items takes up precious space along the top portion of the ironing board and have a tendency to get in the way when larger pieces of fabric need to be ironed. Moreover, the precarious nature of suspending such items from the side of the ironing board often results in one or both items falling to the floor and breaking or becoming soiled.

Accordingly, it would be beneficial to provide an ironing board attachment device that can be secured to an ironing board so as to alleviate the above noted drawbacks.

### SUMMARY OF THE INVENTION

The present invention is directed to an ironing board attachment device. One embodiment of the present invention can include a main body having at least one cup holder that extends upward from the front end. A raised ledge can extend along a perimeter of the main body and can include a curvilinear shape for being engaged by a clothes hanger.

In one embodiment, the device can include a bracket and locking mechanism that can be positioned along the top surface of the main body. The bracket and locking mechanism including functionality to removably engage the frame of an ironing board so as to secure the device onto the side of the ironing board without touching the top surface of the ironing board.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of an ironing board attachment device that is useful for understanding the inventive concepts disclosed herein.

FIG. 2 is a side view of the ironing board attachment device in accordance with one embodiment of the invention.

FIG. 3 is a perspective view of the ironing board attachment device in operation, in accordance with one embodiment of the invention.

FIG. 4 is a side view of the ironing board attachment device in operation, accordance with one embodiment of the invention.

FIG. 5 is a perspective view of the ironing board attachment device in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, the term “removably secured” and derivatives thereof shall be used to describe a situation wherein two or more objects are joined together in a non-permanent manner so as to allow the same objects to be repeatedly joined and separated. This can be accomplished through the use of any number of commercially available connectors such as opposing strips of hook and loop material (i.e. Velcro®), magnets, and/or compression fittings such as locking pins, clamps, nut/bolts, tethers (e.g., zip ties), snaps and buttons, for example.

Moreover, the term “permanently secured” shall be used to describe a situation wherein two or more objects are joined together in a manner so as to prevent the same objects from being separated. Several nonlimiting examples include various adhesives such as glue or resin, hardware such as nuts and bolts, and welds, for example.

As described throughout this document, the term “complementary shape,” and “complementary dimension,” shall be used to describe a shape and size of a component that is identical to, or substantially identical to the shape and size of another identified component.

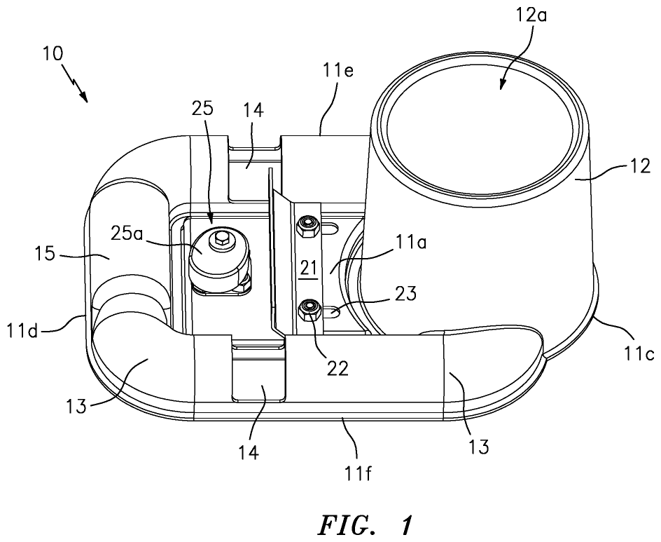

FIGS. 1-5 illustrate various embodiments of an ironing board attachment device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

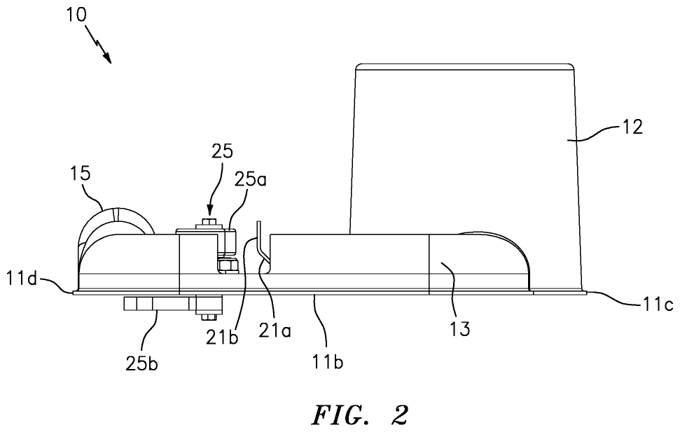

As shown best in FIGS. 1 and 2, the device 10 can include an elongated main body member having a top surface 11a, a bottom surface 11b, a front end 11c, a back end 11d, and a pair of sides 11e and 11f. As described herein, the main body and the below described components may be formed from materials that are, for example, relatively strong and stiff for their weight. Several nonlimiting examples include but are not limited to various metals or metal alloys (e.g., aluminum, steel, titanium, or alloys thereof), plastic/polymers (e.g., high-density polyethylene (HDPE), rigid polyvinyl chloride (PVC), or polyethylene terephthalate (PET)), and/or various composite materials (e.g., carbon fibers in a polymer matrix, fiberglass, etc.).

In one embodiment, a cup holder 12 can be positioned along the front end 11c and can extend upward from the top surface 11a. The cup holder 12 may be formed as an integral component with the main body and can include any number of different shapes and sizes having a hollow interior portion 12a for receiving and storing a spray bottle or other such item.

In one embodiment, a raised lip 13 having a continuous and curved upper surface can extend from the top surface 11a along the outer perimeter of each of the back end 11d and side walls 11e-11f, respectively. The raised lip may also be formed as an integral component with the main body and can function to receive the curved end of a clothes hanger, so as to allow the same to be suspended from the device 10 during operation.

In one embodiment, a pair of apertures 14 can be disposed along the raised lip 13 at locations along each of the side walls 11e and 11f. Additionally, a protrusion 15 can be positioned along the center portion of the back end 11d and can extend upward from the raised lip 13.

An elongated bracket 21 can be positioned along the top surface of the main body 11a. In one embodiment, the bracket can be permanently secured to the main body so as to be at a fixed position and orientation. Conversely, the bracket can be secured to the main body in a moveable manner, so as to be able to pivot, rotate and/or slide along the length of the main body. Such a feature allowing the device to be adjustable in order to conform to ironing boards having a non-standard sidewall configuration. In such an embodiment, the bracket can be secured to the main body via bolts 22 which can be located through elongated slots 23 on the main body. Of course, any number of other devices capable of securing the bracket to the main body are also contemplated.

In either instance, the bracket can be positioned between the side walls 11e and 11f and can include an angled bottom portion 21a and a vertical upper portion 21b that are located linearly between the apertures 14. As will be described below, the vertical upper portion of the bracket is designed to engage a side portion of an ironing board frame, and the angled bottom portion is designed specifically to create a gap into which the ironing board fabric can be positioned. Such a feature ensures the ironing board fabric will not bunch or wrinkle when the device is clamped to the side of an ironing board.

A locking mechanism 25 can be secured along the main body at a location between the bracket 21 and the back end 11d. In the preferred embodiment, the locking mechanism can include a cam 25a that is positioned along the top end of the main body 11a, that is operable by a lever 25b located beneath the bottom end of the main body 11b, whereby turning of the lever results in commensurate angular rotation of the cam body. Of course, the device is not limited to the use of a cam-style locking mechanism, as any number of other devices capable of removably securing the device 10 to an ironing board are also contemplated.

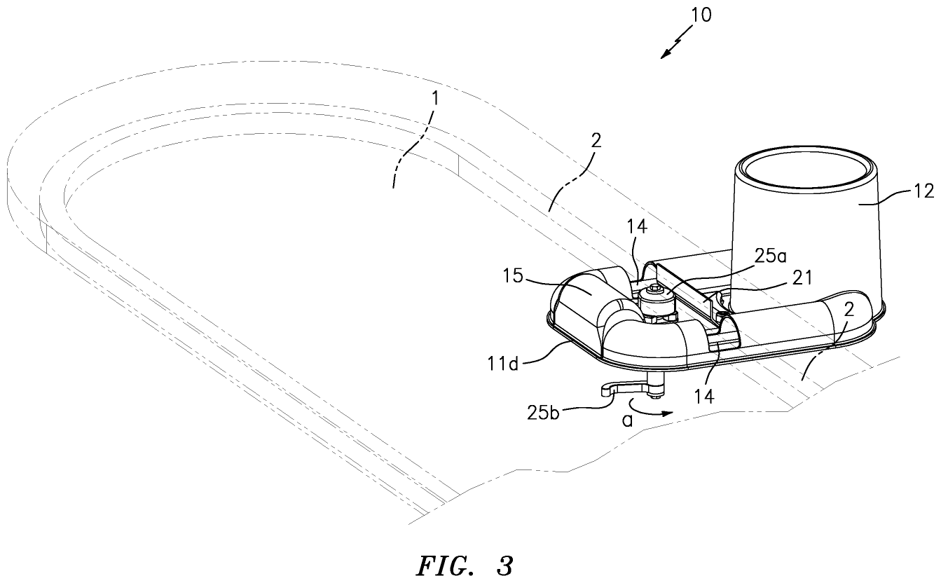

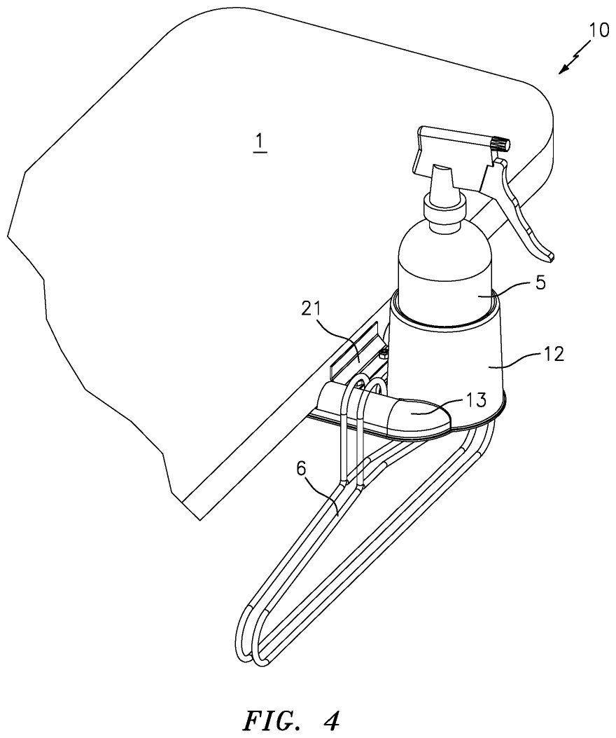

FIGS. 3 and 4 illustrate one embodiment of the device 10 in operation. As shown the back end 11d of the main body can be positioned beneath the main body of an ironing board 1 so that the protrusion 15 is in contact with the bottom surface, and the metallic frame 2 of the ironing board extends through the apertures 14. Next, the lever 25b can be rotated (see arrow a) causing the cam 25a to sandwich the frame 2 against the bracket 21. In this regard, it is noted that the shape, size and placement of the locking mechanism, the bracket and the apertures are complementary to the shape and size of a frame portion of an ironing board so as to be secured thereto.

As ironing boards typically include a frame member having a height of 1 inch, it is preferred that the top of the protrusion 15 include a complementary height that is also 1 inch from the top surface 11a. Such a feature ensuring that when the device is positioned onto the ironing board, as described above, the device 10 will extend horizontally outward from one side of the ironing board in a completely level orientation. This is an important feature, as this allows any number of clothes hangers 6 to be hung from the raised sides 13 of the device without sliding off, and for allowing easy access to a water bottle 5 stored within the cup holder.

Moreover, owing to the unique arrangement of the apertures and locking mechanism, no portion of the device 10 makes contact with the top surface of the ironing board. Such a feature advantageously frees up space to allow for maxim usability of the board when the device 10 is secured thereto. Moreover, because the top surface 11a is recessed relative to the sides 13, this portion functions as a useful shelf onto which additional items can be stored.

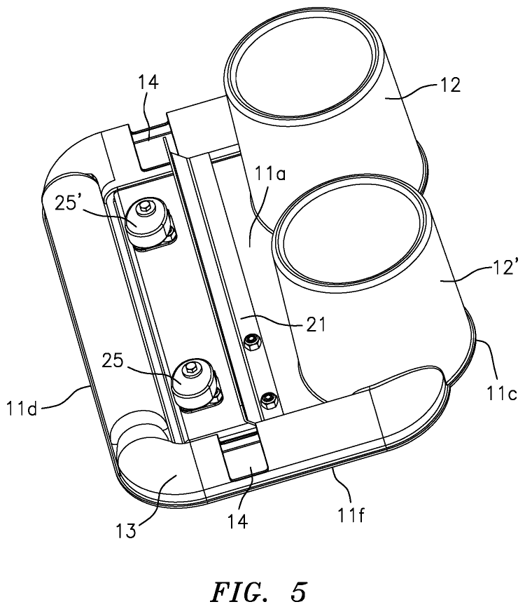

Although illustrated with regard to a single cup holder and/or locking mechanism, other embodiments are also contemplated. To this end, FIG. 5 illustrates one embodiment of the device 10 that includes a widened main body for accommodating two cup holders 12 and 12′, and having two locking mechanisms 25 and 25′. As described herein, elements 12′ and 25′ include identical descriptions and functionality as components 12 and 25, respectively.

Accordingly, the above described ironing board attachment device 10 functions to provide increased functionality for storage of ironing accessories and hanging clothes, in a manner that does not reduce operable space on the board itself.

As described herein, one or more elements of the ironing board attachment device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An ironing board attachment device, comprising: A main body having a top surface, a bottom surface, a front end, a back end and a pair of sides; at least one cup holder that extends upward from the front end of the main body; a bracket that is positioned along the top surface of the main body, said bracket extending between the pair of sides; and a locking mechanism that is positioned along the top surface of the main body at a location adjacent to the bracket, wherein the bracket and locking mechanism are configured to engage to the side frame of an ironing board and to secure the back end of the main body beneath the ironing board without engaging with the top surface of the ironing board.

2. The device of claim 1, further comprising: A raised, curved lip that extends about 1 inch from the top surface of the main body along each of the back end and the pair of sides the main body

3. The device of claim 2, wherein the raised lip includes a curved shape that is about 1 inch tall and at least 1.5 inches wide to be engaged by a curved portion of a clothes hanger, reducing instances of clothes hanger rocking while the ironing board is in use.

4. The device of claim 2, further comprising: a protrusion that further extends upward from the raised lip along the back end of the main body.

5. The device of claim 4, wherein the protrusion includes at least a 0.5-inch height that is complementary to a height of the side frame of an ironing board to keep the device level and prevent teetering while in use.

6. The device of claim 1, wherein the locking mechanism includes a cam that is positioned above the top surface of the main body, and a lever that is positioned beneath the bottom surface of the main body. The lever is turned to secure the device to the side frame of an ironing board without using the top and bottom surface of the ironing board. This allows the top surface of an ironing board to be free from any part of the device.

7. The device of claim 1, additionally comprising at least one cup holder comprises a single cup holder.

8. (canceled)
